(19) United States
(12) Patent Application Publication
(10) Pub. No.: US 2010/0096576 A1
(43) Pub. Date: Apr. 22, 2010

(54) VALVE BLEED SYSTEM

(76) Inventors: Mark Sommer, Cedar Falls, IA (US); Phil Roe, Eldora, IA (US); Derek Eagles, Cedar Falls, IA (US); Paul Seeber, Hudson, IA (US)

Correspondence Address: DEERE & COMPANY, ONE JOHN DEERE PLACE, MOLINE, IL, 61265, US

(21) Appl. No.: 12/256,190

(22) Filed: Oct. 22, 2008

(51) Int. Cl. F16K 31/02

(52) U.S. Cl. 251/129.15

(57) ABSTRACT

A valve control unit is connected to a control valve and automatically moves a valve spool first and second bleed positions. The control unit prevents valve bleed if the control valve is in its extend or retract position under command of the operator. The control unit prevents a valve bleed if a temperature of oil in the reservoir is not less than a reference temperature. The control unit prevents a valve bleed if a speed of the vehicle is less than a reference speed. The control unit automatically returns the spool to its neutral position from the first and second bleed positions.

### FIELD OF THE INVENTION

The present invention relates to a bleed system for a valve of a vehicle hydraulic system.

### BACKGROUND OF THE INVENTION

Utility vehicles, such as tractors, often include hydraulic directional control valves known as selective control valves, or “SCVs”. These SCVs typically include a main valve spool and pilot operated check valves between the valve spool and the hydraulic connectors to which a hydraulic function, such as a cylinder, can be connected. Such valves may trap oil at a low leakage rate between the valve spool and the pilot operated check valves when the main spool is in a neutral position. As a result, thermal expansion of the oil can create pressures that can damage the valves. It is known to protect valves from such damage by providing a physical relief valves in the system. Such thermal relief valves are very common in the hydraulic industry. However, thermal relief valves are costly, they can increase leakage rates, and they have hysteresis which results in an undesirable range of operating points for opening and closing.

### SUMMARY OF THE INVENTION

Accordingly, an object of this invention is to provide a system for automatically bleeding control valves in a vehicle hydraulic system.

A further object of the invention is to provide such a system which valve damage resulting from thermal expansion of trapped oil.

A further object of the invention is to provide such a system which does not require physical relief valves.

These and other objects are achieved by the present invention, wherein a vehicle hydraulic system includes a solenoid operated directional control valve having a valve spool for controlling communication between a pump, a reservoir and first and second work ports. The valve spool is movable from a neutral position to an extend position and to a retract position. The valve spool is also movable to respective first and second bleed positions wherein the respective work port is communicated with the reservoir before the other work port is communicated with the pump. An automatic valve bleed control system includes a valve control unit connected to the control valve and automatically generating first and second bleed commands. The valve spool is movable, in response to the first bleed command, to a first bleed position wherein a first one of the work ports is communicated with the reservoir before a second one of the work ports is communicated with the pump. The valve spool is also movable, in response to the second bleed command, to a second bleed position wherein the second work port is communicated with the reservoir before the first work port is communicated with the pump. The control unit generating the first bleed command to hold the spool in the first bleed position for a shorter first time period, after which the control unit generates a neutral command to hold the spool in its neutral position for a second longer time period, and after which the control unit generates the second bleed command to hold the spool in the second bleed position for a third time period.

The control unit prevents generation of a bleed command if the control valve is in its extend or retract position under command of the operator. The control unit prevents generation of a bleed command if a temperature of oil in the reservoir is not less than a reference temperature. The control unit prevents generation of a bleed command if a speed of the vehicle is less than a reference speed. The control unit automatically returns the spool to its neutral position after the first and second bleed commands have been generated.

### BRIEF DESCRIPTION OF THE DRAWINGS

FIG. 1 is a schematic diagram of a valve control system embodying the present invention;

FIG. 2 is a sectional view of the SCV valve of FIG. 1; and

FIG. 3 is a logic flow diagram of an algorithm executed by the valve controller of FIG. 1.

### DESCRIPTION OF THE PREFERRED EMBODIMENT

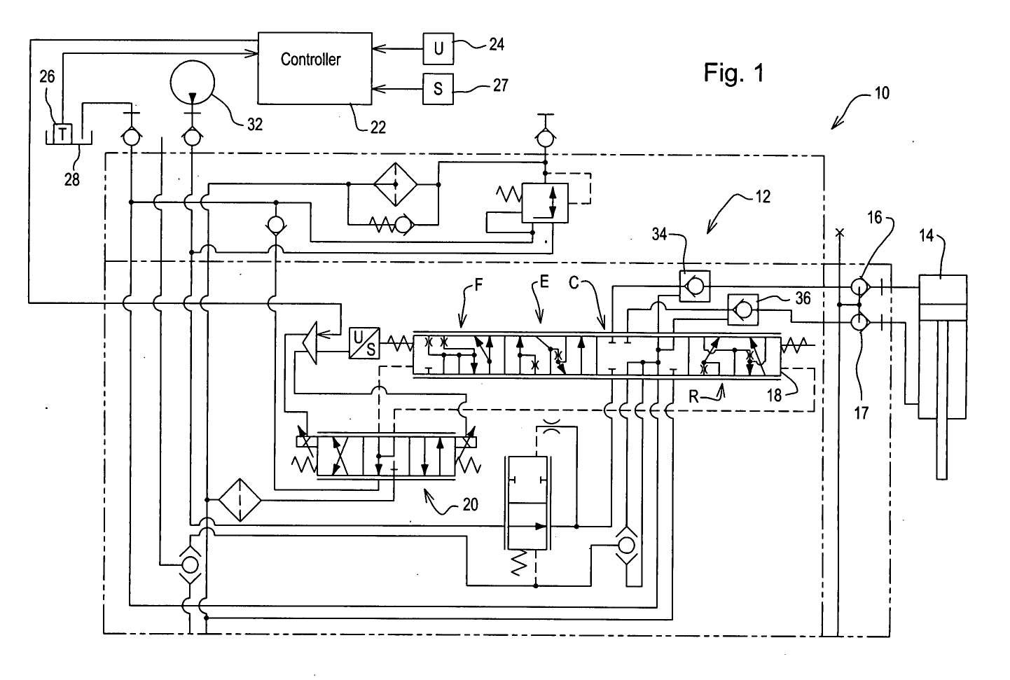

Referring to FIG. 1, an SCV control system 10 includes an SCV 12 which has a main spool 18 which controls the flow of pressurized hydraulic fluid to a hydraulic function, such as a hydraulic cylinder 14 which is connected to valve 12 by hydraulic connectors 16 and 17 and pilot operated check valves 34 and 36. Main spool 18 is moved by hydraulic pressure controlled by solenoid operated pilot valve 20. Valve 12 is connected to a hydraulic (clean oil) reservoir 28 and to a pump 32. Valve 12 is controlled by an electronic control unit (ECU) 22 which supplies signals to the solenoids of the pilot valve 20. ECU 22 responds to the operation of a conventional control valve lever 24, and receives a temperature signal from temperature sensor 26 and a tractor speed signal from a tractor speed sensor 27. Spool 18 is movable from a neutral or closed position N, to a retract position R, an extend position E and to a float position F.

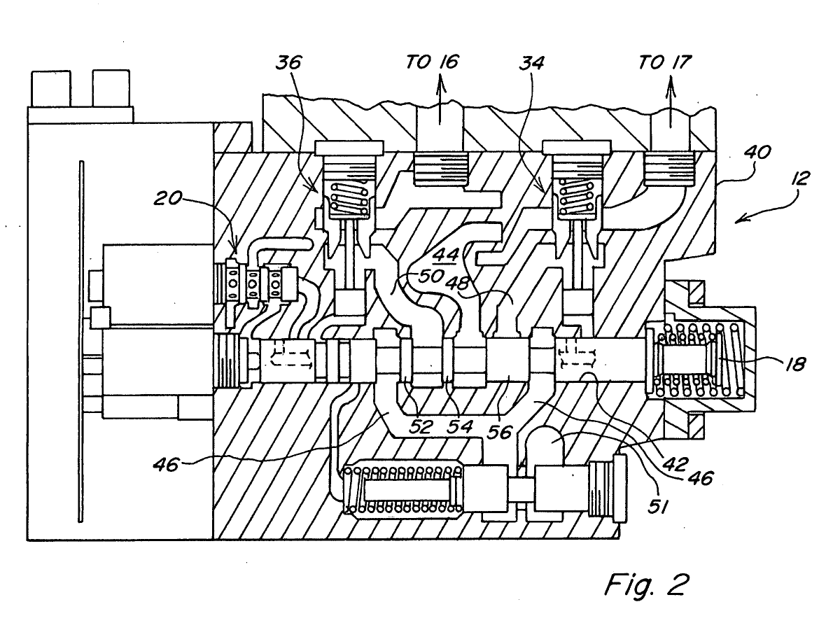

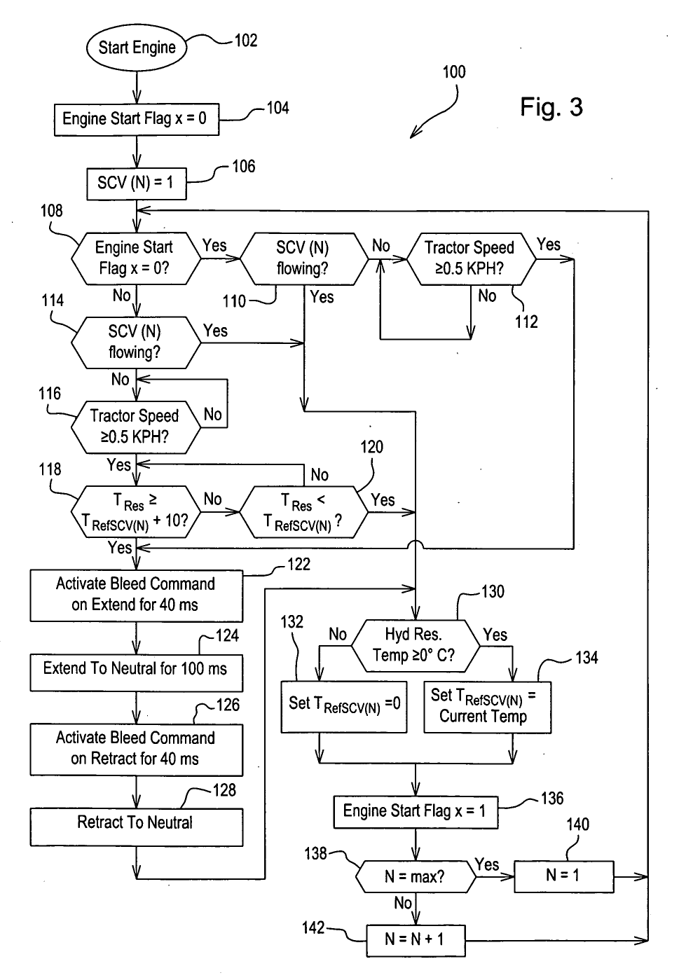

As best seen in FIG. 2, valve 12 is a conventional SCV and includes a housing 40 with a main valve bore 42. Spool 18 is shown in the neutral position and is controlled by pilot valve 20. Valve bore 42 is communicated with a tank or sump passage 44, a pair of pump passages 46, and a pair of work ports 48 and 50. Pump passages 46 are communicated to a pump port 51. Work ports 48 and 50 are connected to the cylinder 14 check valves 34 and 36, and to connectors 16 and 17, respectively. Spool 18 includes lands 52, 54 and 56. The lands and passages are dimensioned so that when spool 18 is moved a small distance to the right, such as ______ mm for example, land 56 communicates tank passage 44 to work port 48 before land 52 communicates pump passage 46 to work port 50. This bleeds and releases trapped pressurized fluid from work port 48. Similarly, when spool 18 is moved a small distance to the left, such as mm for example, land 54 communicates tank passage 44 to work port 50 before land 56 communicates pump passage 46 to work port 48. This bleeds and releases trapped pressurized fluid from work port 50. The valve control unit (VCU) 22 repeatedly executes an algorithm 100 represented by FIG. 3. The conversion of the above flow chart into a standard language for implementing the algorithm described by the flow chart in a digital computer or microprocessor, will be evident to one with ordinary skill in the art.

The algorithm starts at step 102 upon start-up of the vehicle engine (not shown).

Step 104 sets an Engine Start Flag X=0.

Step 106 sets an SCV index number (N)=1.

If the Engine Start Flag X=0, then step 108 directs control to step 110, else to step 114.

If the Nth SCV is flowing, step 110 directs control to step 130, else to step 112.

If tractor speed is greater than or equal to a threshold speed, such as 0.5 KPH, then step 112 directs control to step 122, else to back to step 112.

If the Nth SCV is flowing, step 114 directs control to step 130, else to step 116.

If tractor speed is greater than or equal to a threshold speed, such as 0.5 KPH, then step 116 directs control to step 118, else to back to step 116.

If the clean oil reservoir temperature Tres, is greater than or equal to a reference temperature TrefSCV(N) associated with the Nth SCV plus 10 degrees (F. or C), then step 118 directs control to step 122, else to step 120.

If the clean oil reservoir temperature Tres, is less than reference temperature TrefSCV(N), then step 120 directs control to step 130, else back to step 118.

Step 122 generates an extend bleed command for 40 milliseconds. This causes the spool 18 to move to the left, viewing FIG. 2, to an extend bleed position wherein port 48 is connected to reservoir passage 44 while port 50 remains blocked with respect to both pump passage 46 and reservoir passage 44.

Step 124 then generates a neutral command which moves spool 18 to its neutral position for 100 milliseconds.

Next, step 126 generates a retract bleed command for 40 milliseconds. This causes the spool 18 to move to the right viewing FIG. 2, to a retract bleed position wherein port 50 is connected to reservoir passage 44 while port 48 remains blocked with respect to both pump passage 46 and reservoir passage 44.

Step 128 generates a command to move the spool back to neutral, then directs control to step 130.

If the hydraulic reservoir 28 temperature is greater than or equal to 0 degrees C., then step 130 directs control to step 134, else to step 132.

Step 132 sets the reference hydraulic reservoir temperature for the Nth valve, TRefSCV(N), equal to 0, then directs control to step 136.

Step 134 sets the reference hydraulic reservoir temperature TRefSCV(N) equal to the current temperature, as sensed by sensor 26, then directs control to step 136.

Step 136 sets the Engine Start Flag X=1, then directs control to step 138.

If N is equal to its maximum value, indicating that this process has been performed for all SCVs, then step 138 directs control to step 140, else to step 142.

Step 140 sets the SCV index N=1, and directs control to step 108.

Step 142 increases the SCV index value N by 1, and directs control to step 108.

The resulting system automatically commands the valve spool 18 to move to a position where one of the ports is allowed to drain without opening the pressure port, so that trapped pressure in the system is bled. This command can be issued at several points in the operation of the tractor, such as startup, engine running and engine shutdown. This prevents the pressure from building up to a point where a physical thermal relief valve would be necessary.

The system of this invention generates a first bleed command to hold the spool in the first bleed position for a first time period, after which the control unit generates a neutral command to hold the spool in its neutral position for a second time period, and after which the control unit generates the second bleed command to hold the spool in the second bleed position for a third time period. Preferably, the first time period is shorter (approx. 40 milliseconds) than the second time period (approx. 100 milliseconds). Preferably, the first time period is equal to the third time period.

Preferably, the control unit prevents generation of a bleed command if the control valve is in its extend or retract position, prevents generation of a bleed command if a temperature of oil in the reservoir is not less than a reference temperature, and prevents generation of a bleed command if a speed of the vehicle is less than a reference speed.

Preferably, the control unit automatically returns the spool to its neutral position after the first and second bleed commands have been generated.

This system can be used to limit pressure buildup in an uncoupled SCV to a pressure such as 350 Bar by allowing a retract or extend command to bleed off the pressure between the valve checks and coupler.

The length of time to issue the bleed command to both the extend and retract ports should be minimized to assure the decay of 350 BAR of pressure to less than 25 BAR for an uncoupled valve, but limit the amount of oil bleed from the port. This time can be determined experimentally based on lab tests and simulations. The expected time is preferably less than 40 milliseconds and preferably between 10 to 20 milliseconds.

Preferably, a bleed event is prevented if hydraulic reservoir temperatures is less than 0 degrees C.

Preferably, as a special case, after tractor start, a bleed event is performed only if the tractor speed is not less than 0.5 kph. Then, after tractor motion has begun, subsequent bleed events require both a reservoir temperature change of 10 deg C. and a vehicle speed not less than 0.5 kph.

Preferably, a bleed event may be commanded to occur on all valves for both retract and extend, unless a valve is currently commanded by the operator to be flowing oil, in which case the bleed event can be skipped.

The reference temperature from which the 10 deg C. increase is measured and set at the following conditions: 1) when the tractor is initially started, 2) when a bleed event is commanded, and 3) while the tractor is running for every 1 degree C. decrease in reservoir temperature from the last set point.

This feature can be added at a low product cost in software with a high reliability. The pressure relief can be programmed to only occur when the potential for pressure increases due to thermal expansion are present. There is no hysteresis like physical relief valves as the valve spool is commanded to a specific position. In a hydraulic system having multiple control valves, the system operates to automatically and sequentially bleed the control valves.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. In a vehicle hydraulic system having a solenoid operated directional control valve having a valve spool for controlling communication between a pump, a reservoir and first and second work ports, the valve spool being movable from a neutral position to an extend position and to a retract position, the valve spool also being movable to respective first and second bleed positions wherein the respective work port is communicated with the reservoir before the other work port is communicated with the pump, a valve bleed control system comprising:
a valve control unit connected to the control valve and automatically generating first and second bleed commands, the valve spool being movable, in response to the first bleed command, to a first bleed position wherein a first one of the work ports is communicated with the reservoir before a second one of the work ports is communicated with the pump, the valve spool being movable, in response to the second bleed command, to a second bleed position wherein the second work port is communicated with the reservoir before the first work port is communicated with the pump; and
the control unit generating the first bleed command to hold the spool in the first bleed position for a first time period, after which the control unit generates a neutral command to hold the spool in its neutral position for a second time period, and after which the control unit generates the second bleed command to hold the spool in the second bleed position for a third time period.

2. The valve bleed system of claim 1, wherein:
the first time period is shorter than the second time period.

3. The valve bleed system of claim 2, wherein:
the first time period is equal to the third time period.

4. The valve bleed system of claim 2, wherein:
the control unit prevents generation of a bleed command if the control valve is in its extend position.

5. The valve bleed system of claim 2, wherein:
the control unit prevents generation of a bleed command if the control valve is in its retract position.

6. The valve bleed system of claim 1, wherein:
the control unit prevents generation of a bleed command if a temperature of oil in the reservoir is not less than a reference temperature.

7. The valve bleed system of claim 6, wherein:
the control unit modifies the reference temperature if the valve is commanded to flow oil.

8. The valve bleed system of claim 1, wherein:
the control unit prevents generation of a bleed command if a speed of the vehicle is less than a reference speed.

9. The valve bleed system of claim 1, wherein:
the control unit automatically returns the spool to its neutral position after the first and second bleed commands have been generated.

10. In a vehicle hydraulic system having a solenoid operated control valve having a valve spool for controlling communication between a pump, a reservoir and a work port, the valve spool being movable from a neutral position to a work position, the valve spool also being movable to a bleed position wherein the work port is communicated with the reservoir before a further work port is communicated with the pump, a valve bleed control system comprising:
a temperature sensor for sensing a temperature of hydraulic fluid in the reservoir and generating a temperature signal; and
a valve control unit which receives the temperature signal, the control unit automatically generating a bleed command when the sensed temperature is at least a reference temperature, the valve spool being movable, in response to the bleed command, to the bleed position.

11. The valve bleed system of claim 10, wherein:
the control unit generates a first bleed command to hold the spool in a first bleed position for a first time period, after which the control unit generates a neutral command to hold the spool in its neutral position for a second time period, and after which the control unit generates a second bleed command to hold the spool in a second bleed position for a third time period.

12. The valve bleed system of claim 11, wherein:
the first time period is shorter than the second time period.

13. The valve bleed system of claim 12, wherein:
the first time period is equal to the third time period.

14. The valve bleed system of claim 10, wherein:
the control unit prevents generation of a bleed command if the control valve is being commanded to flow oil by an operator.

15. The valve bleed system of claim 10, wherein:
the control unit automatically returns the spool to its neutral position after a bleed command has been generated.

16. The valve bleed system of claim 10, wherein:
the control unit modifies the reference temperature if the valve is commanded to flow oil.

17. The valve bleed system of claim 10, further comprising:
a vehicle speed sensor for sensing a speed of the vehicle and generating a speed signal which is communicated to the valve control unit, the control unit automatically generating a bleed command when the vehicle speed is at least a threshold speed and the sensed temperature is at least a reference temperature, the valve spool being movable, in response to the bleed command, to the bleed position.

18. In a vehicle hydraulic system having a solenoid operated control valve having a valve spool for controlling communication between a pump, a reservoir and a work port, the valve spool being movable from a neutral position to a work position, the valve spool also being movable to a bleed position wherein the work port is communicated with the reservoir before a further work port is communicated with the pump, a valve bleed control system comprising:
a temperature sensor for sensing a temperature of hydraulic fluid in the reservoir;
a vehicle speed sensor for sensing a speed of the vehicle; and
a valve control unit connected to the temperature sensor, to the speed sensor and to the control valve, the control unit automatically generating a bleed command when the vehicle speed is at least a threshold speed and the sensed temperature is at least a reference temperature, the valve spool being movable, in response to the bleed command, to the bleed position.
